(19) United States
(12) Patent Application Publication
(10) Pub. No.: US 2014/0097560 A1
(43) Pub. Date: Apr. 10, 2014

(54) METHOD FOR FABRICATING SMALL-SCALE, CURVED, POLYMERIC STRUCTURES

(71) Applicant: NATIONAL TSING HUA UNIVERSITY, Hsin Chu City (TW)

(72) Inventors: Ting-Ya CHANG, Taipei City (TW); Chao-Min CHENG, New Taipei City (TW)

(73) Assignee: NATIONAL TSING HUA UNIVERSITY, Hsin Chu City (TW)

(21) Appl. No.: 13/752,029

(22) Filed: Jan. 28, 2013

(30) Foreign Application Priority Data
Oct. 5, 2012 (TW) 101136977

(51) Int. Cl. B29C 35/08

(52) U.S. Cl. CPC B29C 35/0805
USPC 264/494

(57) ABSTRACT

A method is proposed for fabricating small-scale, curved, polymeric structures. Firstly, desired patterns are created from droplets of photocurable PDMS after using ink or wax to create the desired patterns on a flexible material such as papers or plastic films. The photocurable PDMS droplets are then activated by UV light to form a small-scale polymeric mold. Next, polymeric curved structures can be obtained at millimeter scale by casting and curing thermocurable PDMS on the mold.

### TECHNICAL FIELD

The present invention is generally relevant to polymeric structures, more specifically, to a method for fabricating small-scale, curved, polymeric structures.

### BACKGROUND

One of the various materials used to make cell-based assays is polydimethylsiloxane (PDMS), an inert and non-toxic silicone-based polymer. Because of its mechanical, chemical, and optical properties, PDMS has many biomedically relevant applications, including fabrication of artificial organs, prostheses, catheters, contact lenses, as well as drug delivery systems. Non-biomedical applications include microfluidic devices, microreactors, lab-on-a-chip diagnostics, soft-lithography, membranes, electrical insulators, water repellents, anti foaming agents, adhesives, protective coatings, and sealants.

Many attractive characteristics of PDMS include its chemical inertness, non-toxicity, easy-handled, and commercial availability. Many PDMS surface modification strategies have been developed, including physisorption and chemical coupling. Physisorption of materials such as surfactants (Huang, B.; et al. Science 2007, 315, 81-84) and polyelectrolytes (Liu, Y; et al. Anal. Chem. 2000, 72, 5939-5944) to the PDMS surface is driven by hydrophobic and electrostatic forces, respectively. Chemical coupling is stable but generally requires high-energy (i.e., plasma) bombardment of the PDMS surface (Donzel, C.; et al. Adv. Mater. 2001, 13, 1164).

The PDMS is commercially available from several vendors as a two-part kit containing an elastomer base and a cross-linking agent, both of which are sold in liquid form. Kits are also available in varying molecular weights and/or varying branches of the elastomer base. Polymerization is initiated by mixing the elastomer base with the cross-linking agent. The resulting rubbery solid PDMS elastomer is optically transparent and has a hydrophobic surface. Although the hydrophobic nature of PDMS is often an undesirable characteristic, it is essential for microfluidic devices with hydrophilic surfaces to allow polar liquids to pass through. Biomedical devices such as contact lenses are easily wetted to improve user's comfort. Various strategies used to obtain a hydrophilic surface in PDMS include exposure to oxygen plasma, ozone, corona discharge, and ultraviolet light. Additionally, a hydrophilic surface can be modified by physical adsorption of charged surfactants, by adding polyelectrolyte multilayers, and by using a swelling-deswelling method to entangle amphiphilic co-polymers in an organic solvent. Covalent modification of the PDMS surface requires a surface activation process, generally by oxidation reaction followed by solvent or chemical vapor deposition of the reactive molecule. A cost-effective method is needed to render PDMS with desired hydrophilic properties but without compromised mechanical, optical, or gas permeability properties.

Obtaining a PDMS surface pattern requires the placement of a photo-mask above the surface of the functionalized PDMS substrate to enable selective functionalization of the PDMS substrate. The PDMS pattern is formed by a traditional photolithography process which requires a photo-mask, followed by an etching process. Therefore, PDMS manufacturing requires specific equipment. For example, U.S. Pat. No. 9,192,922, entitled “Method of optical fabrication of three-dimensional polymeric structures with out of plane profile control”, describes a method of manufacturing three-dimensional polymeric structures by using a photolithography process and an etching process.

To address the shortcomings of PDMS and the difficulties of making PDMS surface patterns, a method is proposed for fabricating small-scale, curved, polymeric structures.

### SUMMARY OF THE INVENTION

To address the above shortcomings, a method is proposed for fabricating small-scale, curved, polymeric structures by casting and curing thermocurable PDMS in photocurable PDMS molds.

Another objective of the invention is to provide a method of fabricating small-scale, curved, polymeric structures applicable in cell-based assays, antibody-based arrays, the development of synthetic biopolymers, tissue engineering, and bio-microelectromechanical systems (Bio-MEMS).

One feature of the invention is its potential use for fabricating small-scale, curved, polymeric structures composed of a flexible material. After the desired pattern is formed by placing liquid-phase photocurable material droplets on the flexible material, the liquid-phase photocurable material droplets are cured to form convex curved small-scale structures.

Another potential application is in casting a thermocurable material on the convex surfaces of small-scale structures. Small-scale structures with concave surfaces can then be formed by curing the thermocurable material.

The material used in the proposed fabrication method is photocurable PDMS or UV crosslinkable material, and the thermocurable material is thermocurable PDMS or thermal crosslinkable material.

After forming a patterned layer on the flexible material, the next step of the method is placing the droplets of liquid-phase photocurable material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The attached specifications and drawings outline the preferred embodiments of the invention, including the details of its components, characteristics and advantages.

FIG. 1 shows a patterned layer formed on the substrate according to one embodiment of the invention;

FIG. 2 shows convex curved small-scale structures formed on the substrate according to one embodiment of the invention;

FIG. 3 shows a cast of a thermocurable material using a small-scale polymeric mold in one embodiment of the invention;

FIG. 4 shows the removal of the concave curved polymeric structures from the mold according to one embodiment of the present invention;

FIGS. 5A-D illustrate arrays of the convex curved structures according to one embodiment of the present invention;

FIGS. 6A and 6C illustrate arrays of the photocurable PDMS molds according to one embodiment of the present invention;

FIGS. 6B and 6D illustrate arrays of the polymeric, curved thermocurable PDMS structures according to one embodiment of the present invention;

FIG. 7 illustrates a statistic analysis of six 4×4 arrays with curved structures on paper according to one embodiment of the present invention;

FIG. 8 illustrates grouped data for the projection area of six 4×4 thermocurable PDMS arrays according to one embodiment of the present invention;

FIG. 9 illustrates grouped data for the projection area of two thermocurable PDMS arrays according to one embodiment of the present invention;

FIGS. 10A-B illustrate the optical properties of the polymeric, curved thermocurable PDMS structures according to one embodiment of the present invention;

FIGS. 11A-F illustrate the optical images of Madin-Darby canine kidney cells on one well of multiple 4×4 arrays made out of thermocurable PDMS with various culture durations according to one embodiment of the present invention;

FIGS. 12A-D illustrate epi-fluorescence images of NIH-3T3 fibroblasts cultured on the concave surface of the PDMS structure after two days of culture according to one embodiment of the invention.

### DETAILED DESCRIPTION

Some preferred embodiments of the invention are next described in further detail. Notably, however, the preferred embodiments of the invention are provided for illustration purposes rather than for limiting the use of the invention. The invention is also applicable in many other embodiments besides those explicitly described, and the scope of the present invention is not expressly limited except as specified in the accompanying claims.

The present invention provides an inexpensive but robust and easily performed approach for fabricating polymeric, curved structures on a paper/or plastic substrate at millimeter scale (or in an array format at millimeter scale) for various applications. Since this simple and inexpensive method is applicable for fabricating biomedical devices, point-of-care diagnostic systems or biomaterials for scaffolds without sophisticated facilities, it can decrease the cost of information in the entire manufacturing process (e.g., materials cost and capital cost) in both developing or industrialized countries. The invention can also be used to fabricate small-scale convex structures (single or multiple structures as an array) via a biocompatible polymer (e.g., photocurable PDMS) producing a phase transition activated by UV light and the surface tension between this polymeric material and the substrate (e.g., an inexpensive material such as paper or plastic film). Potential applications of the invention include cell-based assays, antibody-based arrays, synthetic biopolymers, tissue engineering, and Bio-MEMS. The proposed method of fabricating small-scale, curved, polymeric structures is described further below.

Firstly, a substrate 101 is prepared and formed on (adhered to) tape 100. The substrate 101 is for example a paper or a plastic film (smooth substrate). The preferred thickness of the thin, flexible film used as the plastic film substrate is 0.01˜0.1 centimeters to provide a flexible yet dimensionally stable substrate. The smooth surface of the plastic film provides a suitable surface for bonding to tape 100. This heat stabilization ensures that the plastic film can endure the heat cycle of the curing process without cockling or buckling. Tape 100 may be an adhesive layer (tape).

Potential plastic film materials include triacetate cellulose (TAC), polyethylene, polypropylene, poly(4-methylpentene-1-ene) polyolefin, polyimide, polyamide imide, polyamide, polyether imide, polyether ether ketone, polyketone sulfide, polyether sulfone, polysulfone, polyphenylene sulfide, polyphenylene ketone, polyethylene terephthalateethylene glycol esters, polyethylene terephthalate, polybutylene terephthalate, polyethylene naphthalate glycol esters, polyacetal, polycarbonate, polyacrylate, acrylic resins, polyvinyl alcohol, polypropylene, cellulose-based plastic, epoxy resins, phenol resins, poly-norbornene, polyester, polystyrene, polyvinyl chloride, polyvinylidene chloride, and liquid crystal polymer.

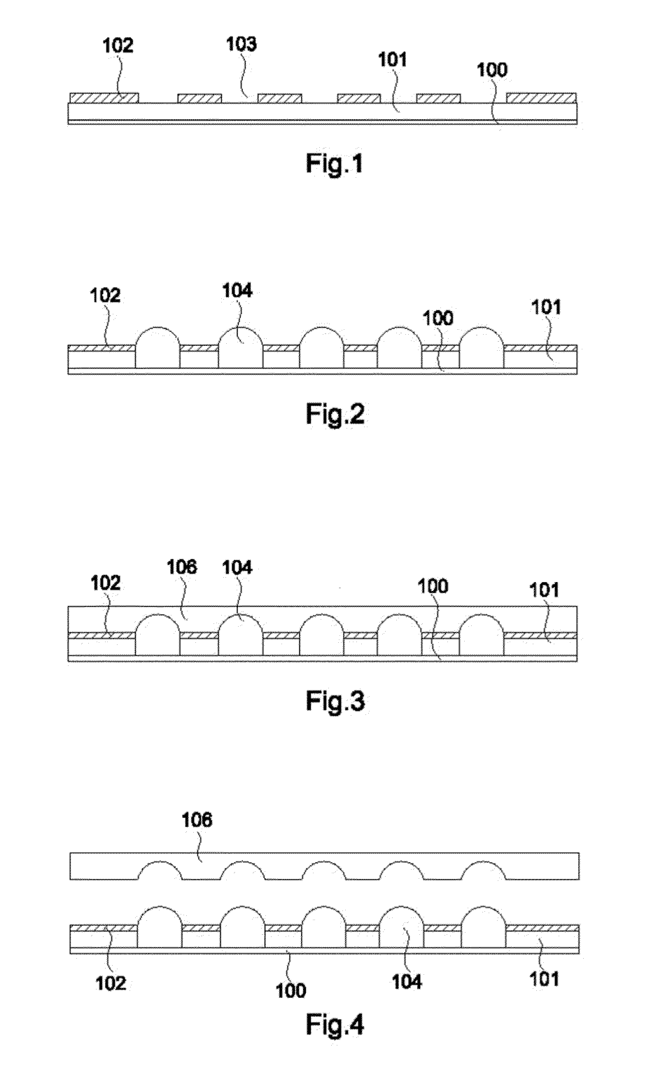

Patterned layer 102 is then formed on substrate 101 to facilitate alignment during the following process. Substrate 101 can be a flexible material with a cost lower than that of a silicon wafer. In one embodiment, a material (such as ink or wax) layer is formed on the substrate 101 to form a patterned layer 102 and a non-patterned area 103, shown in FIG. 1. Patterned layer 102 is formed from material used for laser printing such as toner or carbon powder. Patterned layer 102 can be created by a standard printing process using a commercial printer or by a photomask-free process. Non-patterned area 103 may be designed in an array format at millimeter scale. The liquid-phase photocurable material (e.g., UV-activated material) droplets are dropped/placed onto non-patterned area 103 on substrate 101 to form the desired pattern of liquid-phase photocurable material droplets on substrate 101. The desired patterns created via patterned layer 102 on substrate 101 are formed from either ink or wax material. The liquid-phase photocurable material droplets with the desired patterns are then activated (cured) by exposure to a light source such as UV light. FIG. 2 shows that the convex curved small-scale structure (or multiple structures as an array) 104 is formed on substrate 101 via a combination of the surface tension between the selected substrate 101 and the photocurable material (e.g., polymeric material) and UV activation (e.g., wavelength˜365 nm). Thus, the photocurable material droplets switch from liquid phase to solid phase. The photocurable material, (e.g., UV-activated PDMS), is prepared by mixing prepolymer ((methacryloxypropyl)methylsiloxane-dimethylsiloxane) with 1˜10% (weight in weight: w/w) photoinitiator (2,2-dimethoxy-2-phenylacetophenone). Restated, the photocurable PDMS can be prepared by mixing liquid flexible material with solid powder photoinitiator.

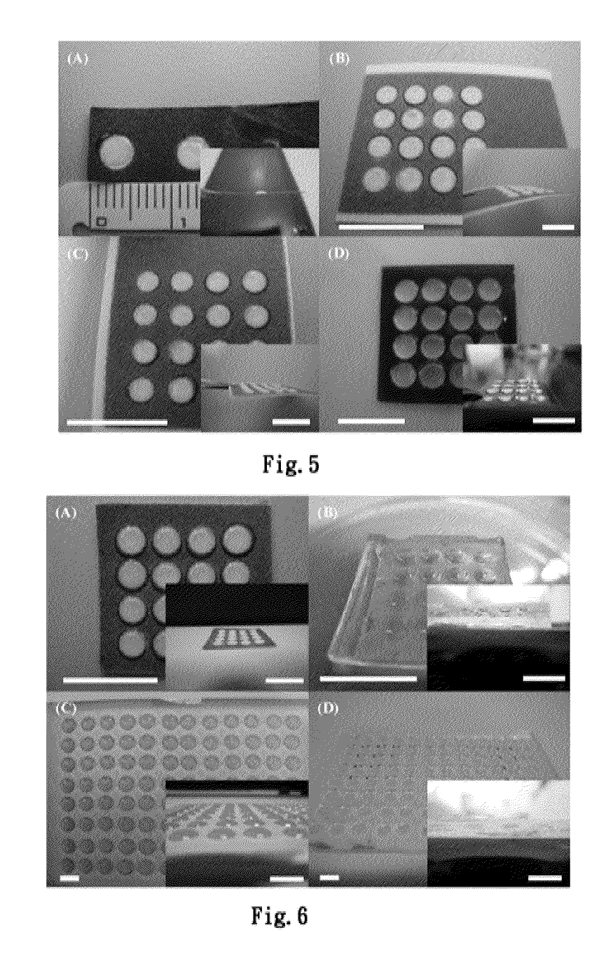

Moreover, the shape of convex-curved small-scale structure 104 depends on the surface tension between the photocurable material and the selected substrate 101 and on the delay between formation of the viscoelastic droplet and activation (crosslink) of photocurable PDMS under UV exposure. For example, FIGS. 5(A, B & C) show arrays of various sizes of curved structures 104 formed from photocurable PDMS droplets on paper. FIG. 5(D) shows an array of the curved structures 104 on a plastic film where patterns were printed with a laser printer. Scale bar is equal to 1 centimeter (cm).

Accordingly, the small-scale polymeric mold and the polymeric, curved structures can be fabricated at millimeter scale (or an array format at millimeter scale) by using a physical-based combination of the phase transition of a biocompatible polymer, such as photocurable PDMS, and the surface tension between this polymeric material and the substrate (i.e., papers or plastic films).

The optical properties of the resulting small-scale convex structure of the photocurable PDMS structure can be modified by adjusting the concentration, molecular weight, configuration, and hydrophobic/hydrophilic balance of the polymer additive(s). Thus, the surface tension between the photocurable PDMS (polymeric material) and the substrate may be modified to change the optical properties of the formed convex small-scale structure of photocurable PDMS. As noted above, a simple and cost-effective technique for forming PDMS is needed. The hydrophobic characteristics of PDMS can be modified by adjusting the preparation conditions and subsequent treatments and exposure environments. By affecting the surface tension between PDMS and the substrate, the hydrophobic characteristic of PDMS can cause variations in the curvature of the PDMS structure.

Another embodiment does not require patterned layer 102. The specified patterns are formed by directly dropping/placing the liquid-phase photocurable material droplets on substrate 101. That is, it does not include the process for forming patterned layer 102. Similarly, the convex curved small-scale structure (or multiple structures as an array) 104 is formed by using UV light to activate (cure) the liquid-phase photocurable material droplets.

In yet another embodiment, the convex small-scale structure 104 has the same pattern as the mold in order to fabricate PDMS-based structures via a molding process. For example, FIGS. 6(A & C) show photocurable PDMS molds with 16 and 96 curved structures 104, respectively (4×4 and 8×12 arrays). FIG. 3 shows a structure cast from a thermocurable material using a small-scale polymeric mold. To cross-link the thermocurable material on photocurable PDMS molds, the thermocurable material is cured at 70° C. for 2 hours. Thus, concave and curved polymeric structures 106 are obtained at millimeter scale by using the mold to cast and cure the thermocurable material (PDMS). FIG. 4 shows curved polymeric structure 106 after its removal from the mold. The bond between the curved polymeric structures 106 and the mold enables easy detachment of the curved polymeric structure 106 from the mold after curing. For example, FIGS. 6(B & D) show examples of polymeric, curved thermocurable PDMS structures 106 prepared by casting and curing thermocurable PDMS in the above two molds (scale bar=1 cm). FIG. 6(B) is an optical image of a thermal-activated PDMS array with 16 small-scale structures. This array may be used for making both cell-based assays and antibody-based arrays.

The photocurable material is photocurable PDMS or UV crosslinkable material (e.g., polyethersulfones), and the thermocurable material is thermocurable PDMS or thermal crosslinkable material (e.g., thermal crosslinkable resin or ethylene-vinyl acetate).

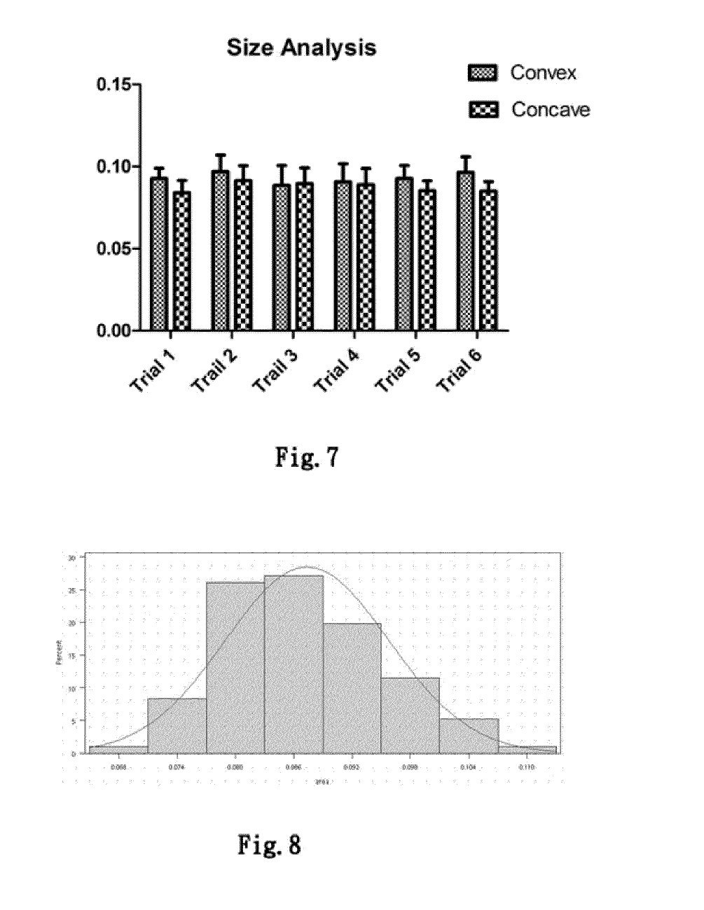

FIG. 7 shows the results of a statistical analysis of six 4×4 arrays with curved structures 104 on paper. The analysis was performed using ImageJ image analysis software (N=6; n=96). In each of the six test samples, the X-coordinate indicates whether the sample is concave or convex, and the Y-coordinate indicates the average projection area of each droplet. The average projection area per droplet (photocurable PDMS mold) approximates 0.0903 cm² with a standard deviation of 0.0099 cm² (11.0% error) whereas the average projection area per droplet (thermocurable PDMS structures) approximates 0.0873 cm² with a standard deviation of 0.0084 cm² (9.62% error).

FIG. 8 shows the grouped data for a projection area of six 4×4 thermocurable PMDS arrays (96 thermocurable PDMS curved structures), which represents a Gaussian distribution.

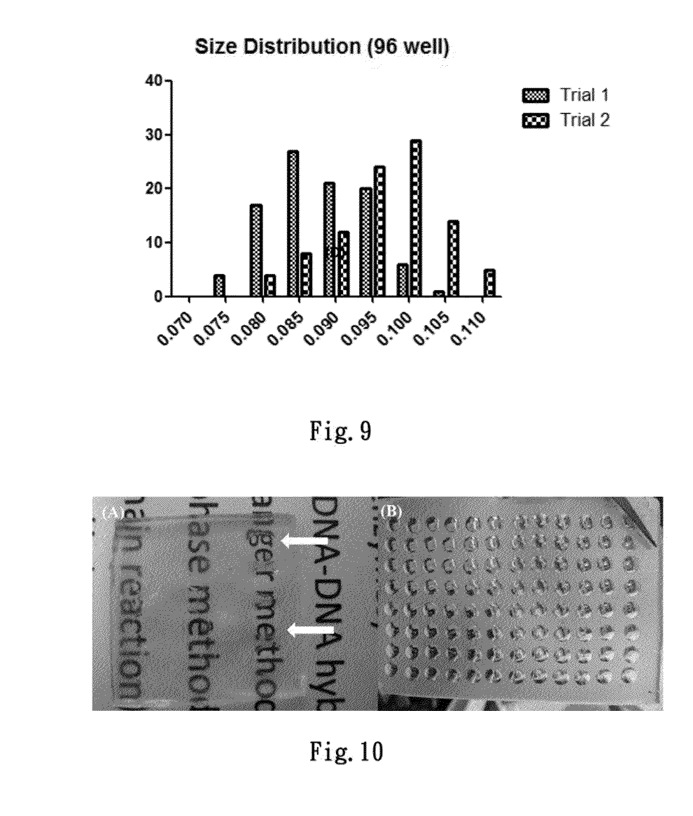

FIG. 9 shows the grouped data for the projection area of two (trial 1 and 2) thermocurable PDMS arrays (96 thermocurable PDMS curved structures) in 96-well format (N=2; n=192). The X-coordinate indicates the projection area (cm²), and the Y-coordinate indicates the percentage (%).

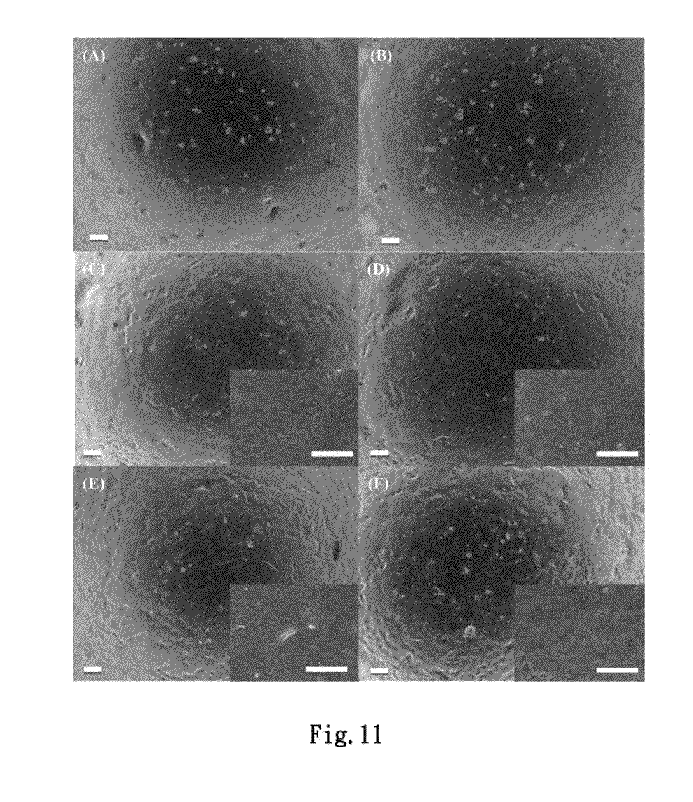

FIGS. 10(A, B) show the optical properties of the concave structures 106 made from thermocurable PDMS. The characters in FIG. 10(A) at the concave location are minimized by the divergence of light passing through the curved structures 106. Moreover, FIG. 11 shows the optical images of Madin-Darby canine kidney cells on one well of multiple 4×4 arrays made from thermocurable PDMS at varying durations of culture; FIGS. 11(A, B) show the initial state, FIGS. 11(C, D) show the state after 24 hours, and FIGS. 11(E, F) show the state after 48 hours (scale bar=100 μm). The left side of FIG. 11(A, C & E) shows the photocurable PDMS mold made on paper, and the right side of FIG. 11(B, D & F) shows the photocurable PDMS mold made on plastic film.

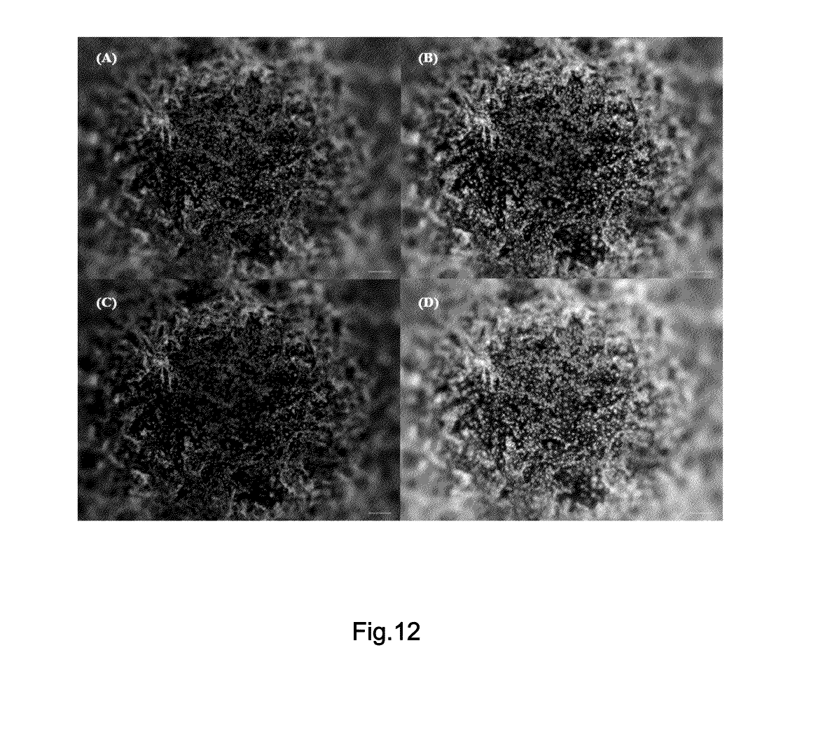

FIGS. 12(A, D) show epi-fluorescence images of NIH-3T3 fibroblasts cultured on the concave PDMS structure after two days of culture (scale bar=100 μm). FIGS. 12(A) and 12(C) show actin filaments with Alexa Fluor 488 phalloidin, and FIGS. 12(B) and 12(D) show merged epi-fluorescence images of actin filaments and nuclei of NIH-3T3 fibroblasts.

The invention described above provides an inexpensive and simple method with many potential applications. For example, the concave structures 106 made of thermocurable PDMS have various applications in cell-based assays and antibody-based assays, such as Enzyme-linked immunosorbent assay (ELISA).

The preferred embodiments described above are illustrations rather than limitations of the applications of the invention. For a person skilled in the art, the preferred embodiments described above are illustrations rather than limitations of the applications of the invention. The present invention is intended to enable various modifications, and similar arrangements are included within the spirit and scope of the appended claims, the scope of which should be accorded the broadest interpretation so as to encompass all such modifications and similar structures.

What is claimed is:

1. A method for fabricating small-scale, curved, polymeric structures, comprising:
providing a flexible material, wherein cost of mentioned flexible material is smaller that of a silicon wafer;
placing liquid-phase photocurable material droplets on mentioned flexible material to form a desired pattern; and
curing mentioned liquid-phase photocurable material droplets to form convex curved small-scale structures.

2. The method of claim 1, further comprising a step of casting a thermocurable material on mentioned convex curved small-scale structures.

3. The method of claim 2, further comprising a step of curing mentioned thermocurable material to form concave curved small-scale structures.

4. The method of claim 2, wherein mentioned thermocurable material is thermocurable PDMS (polydimethylsiloxane) or thermal crosslinkable material.

5. The method of claim 1, further comprising a step of forming a patterned layer on mentioned flexible material prior to mentioned placing liquid-phase photocurable material droplets.

6. The method of claim 5, wherein material of mentioned patterned layer comprises ink, carbon powder, toner or wax.

7. The method of claim 5, further comprising a step of casting a thermocurable material on mentioned convex curved small-scale structures.

8. The method of claim 7, further comprising a step of curing mentioned thermocurable material to form concave curved small-scale structures.

9. The method of claim 8, further comprising a step of removing mentioned concave curved small-scale structures from mentioned convex curved small-scale structures.

10. The method of claim 1, wherein mentioned photocurable material comprises photocurable PDMS (polydimethylsiloxane) or UV crosslinkable material.

11. The method of claim 1, wherein material of mentioned flexible material comprises paper or plastic film.

12. The method of claim 11, wherein mentioned photocurable material comprises photocurable PDMS (polydimethylsiloxane) or UV crosslinkable material.

13. The method of claim 12, further comprising a step of casting a thermocurable material on mentioned convex curved small-scale structures.

14. The method of claim 13, further comprising a step of curing mentioned thermocurable material to form concave curved small-scale structures.

15. The method of claim 14, wherein mentioned thermocurable material is thermocurable PDMS (polydimethylsiloxane) or thermal crosslinkable material.

16. The method of claim 15, further comprising a step of forming a patterned layer on mentioned flexible material prior to mentioned placing liquid-phase photocurable material droplets.

17. The method of claim 16, wherein material of mentioned patterned layer comprises ink, carbon powder, toner or wax.

18. The method of claim 16, further comprising a step of casting a thermocurable material on mentioned convex curved small-scale structures.

19. The method of claim 18, further comprising a step of curing mentioned thermocurable material to form concave curved small-scale structures.

20. The method of claim 19, further comprising a step of removing mentioned concave curved small-scale structures from mentioned convex curved small-scale structures.
